(19) United States
(12) Patent Application Publication
(10) Pub. No.: US 2024/0134602 A1
(43) Pub. Date: Apr. 25, 2024

(54) EFFICIENT FLOATING POINT SQUARER

(71) Applicant: Imagination Technologies Limited, Kings Langley (GB)

(72) Inventors: Max Freiburghaus, Hertfordshire (GB); William Wheeler, Hertfordshire (GB); Daniel Ley, Hertfordshire (GB)

(21) Appl. No.: 18/240,618

(22) Filed: Aug. 31, 2023

(30) Foreign Application Priority Data
Aug. 31, 2022 (GB) 2212602.3

(51) Int. Cl. G06F 7/487

(52) U.S. Cl. CPC G06F 7/4876

(57) ABSTRACT

Methods of squaring, in hardware logic, a floating point number comprising an m-bit input exponent and an input mantissa comprise generating a candidate mantissa output, in mantissa hardware logic, by squaring the input mantissa and generating, in exponent and exception logic, three candidate exponent outputs. The three candidate exponent outputs comprise (i) an exceptional exponent output, (ii) an exponent output generated from the m-bit input exponent and (iii) an incremental exponent generated by incrementing the exponent output. The method further comprises selecting, as the output mantissa, either the candidate mantissa output or an exceptional mantissa output based on exception signals generated by the exponent and exception logic based on the m-bit input exponent. The method additionally comprises selecting, as an output exponent, one of the three candidate exponent outputs based on the exception signals and based on a signal indicating a mantissa overflow condition.

### CROSS-REFERENCE TO RELATED APPLICATION

This application claims foreign priority under 35 U.S.C. 119 from United Kingdom patent application number 2212602.3 filed on 31 Aug. 2022, which is herein incorporated by reference in its entirety.

### BACKGROUND

Floating point representation is widely used in the field of computing because it enables a wide range of values to be represented in an efficient way, e.g. with a relatively small number of bits. A binary floating point number typically comprises a mantissa, mant, and an exponent, exp, both of which comprise a plurality of bits. It may also comprise a sign field or bit, sign (i.e. where the floating point number is a signed, rather than an unsigned, number). The mantissa forms part of the significand, where the significand is given by either 1.mant (where the significand is referred to as ‘normal’) or 0.mant (where the significand is referred to as rdenormall

The exponent, exp, may be a signed integer or an unsigned integer. If the exponent comprises m bits and is a signed integer, the exponent is typically in the range of -2^{m-1} to +2^{m-1}−1. If, however, the exponent is an unsigned integer, the exponent is typically in the range of 0 to 2^{m}−1. Where the exponent is an unsigned integer it is biased by an exponent bias, bias, so that the value of exp-bias is in the range −2^{m-1}+1 to +2m -1 . The value of the bias is dependent upon the value of m and is given by 2^{m-1} −1, e.g. for an 8-bit exponent (m=8), then the bias is 127 (=2⁷−1).

Using the notation set out above, the value represented by a normal floating point number is given by:

(−1)^{sign}×2^{exp-bias}×1.mant

The embodiments described below are provided by way of example only and are not limiting of implementations which solve any or all of the disadvantages of known methods of squaring and multiplying floating point numbers in hardware logic.

### Summary

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described herein are methods of squaring, in hardware logic, a floating point number comprising an m-bit input exponent and an input mantissa. The method comprises generating a candidate mantissa output, in mantissa hardware logic, by squaring the input mantissa and generating, in exponent and exception logic, three candidate exponent outputs. The three candidate exponent outputs comprise (i) an exceptional exponent output, (ii) an exponent output generated from the m-bit input exponent and (iii) an incremental exponent generated by incrementing the exponent output. The method further comprises selecting, as the output mantissa, either the candidate mantissa output or an exceptional mantissa output based on exception signals generated by the exponent and exception logic based on the m-bit input exponent. The method additionally comprises selecting, as an output exponent, one of the three candidate exponent outputs based on the exception signals and based on a signal indicating a mantissa overflow condition.

A first aspect provides a method of squaring a floating point number in hardware logic, the floating point number comprising an m-bit input exponent and an input mantissa, the method comprising: generating a candidate mantissa output, in mantissa hardware logic, by squaring the input mantissa; generating, in exponent and exception logic, three candidate exponent outputs, the three candidate exponent outputs comprising an exceptional exponent output, an exponent output generated from the m-bit input exponent and an incremental exponent, wherein the incremental exponent is generated by incrementing the exponent output generated from the m- bit exponent; selecting, as an output mantissa, either the candidate mantissa output or an exceptional mantissa output based on exception signals generated by the exponent and exception logic based on the m-bit input exponent; and selecting, as an output exponent, one of the three candidate exponent outputs based on the exception signals generated by the exponent and exception logic and based on a signal indicating a mantissa overflow condition.

A second aspect provides hardware logic arranged to square a floating point number, the floating point number comprising an m-bit input exponent and an input mantissa, the hardware logic comprising: mantissa hardware logic arranged to generate a candidate mantissa output by squaring the input mantissa; exponent and exception logic arranged to generate three candidate exponent outputs, the three candidate exponent outputs comprising an exceptional exponent output, an exponent output generated from the m-bit input exponent and an incremental exponent, wherein the incremental exponent is generated by incrementing the exponent output generated from the m-bit exponent; a first multiplexer arranged to select, as an output mantissa, either the candidate mantissa output or an exceptional mantissa output based on exception signals generated by the exponent and exception logic based on the m-bit input exponent; and a second multiplexer arranged to select, as an output exponent, one of the three candidate exponent outputs based on the exception signals generated by the exponent and exception logic and based on a signal indicating a mantissa overflow condition.

The squaring hardware described herein may be embodied in hardware on an integrated circuit. There may be provided a method of manufacturing, at an integrated circuit manufacturing system, a floating point squarer. There may be provided an integrated circuit definition dataset that, when processed in an integrated circuit manufacturing system, configures the system to manufacture hardware configured to perform any of the methods described herein. There may be provided a non-transitory computer readable storage medium having stored thereon a computer readable description of an integrated circuit that, when processed, causes a layout processing system to generate a circuit layout description used in an integrated circuit manufacturing system to manufacture hardware configured to perform any of the methods described herein.

There may be provided an integrated circuit manufacturing system comprising: a non-transitory computer readable storage medium having stored thereon a computer readable integrated circuit description that describes the hardware configured to perform any of the methods described herein; a layout processing system configured to process the integrated circuit description so as to generate a circuit layout description of an integrated circuit embodying the hardware configured to perform any of the methods described herein; and an integrated circuit generation system configured to manufacture the hardware configured to perform any of the methods described herein according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1A is a schematic diagram of first example hardware logic arranged to perform squaring of a normal floating point number;

FIG. 1B is a schematic diagram of second example hardware logic arranged to perform squaring of a normal floating point number that is a variation on that shown in FIG. 1A configured to handle denormal outputs;

FIG. 1C is a schematic diagram of third example hardware logic arranged to perform squaring of a normal floating point number that is a variation on that shown in FIG. 1A;

FIG. 2A is a flow diagram of an example method of operation of the exponent and exception logic of FIG. 1A and 1C;

FIG. 2B is a flow diagram of an example method of operation of the exponent and exception logic of FIG. 1B;

FIG. 3 is a schematic diagram showing an example implementation of the exponent and exception logic of FIG. 1A and 1C in more detail;

FIG. 4A is a graphical representation of the bit manipulation performed by the hardware logic of FIG. 1A and 1C;

FIG. 4B is a graphical representation of the bit manipulation performed by the hardware logic of FIG. 1B; and

FIG. 5 shows an integrated circuit manufacturing system for generating an integrated circuit embodying the hardware logic of FIG. 1A, 1B and/or 1C.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

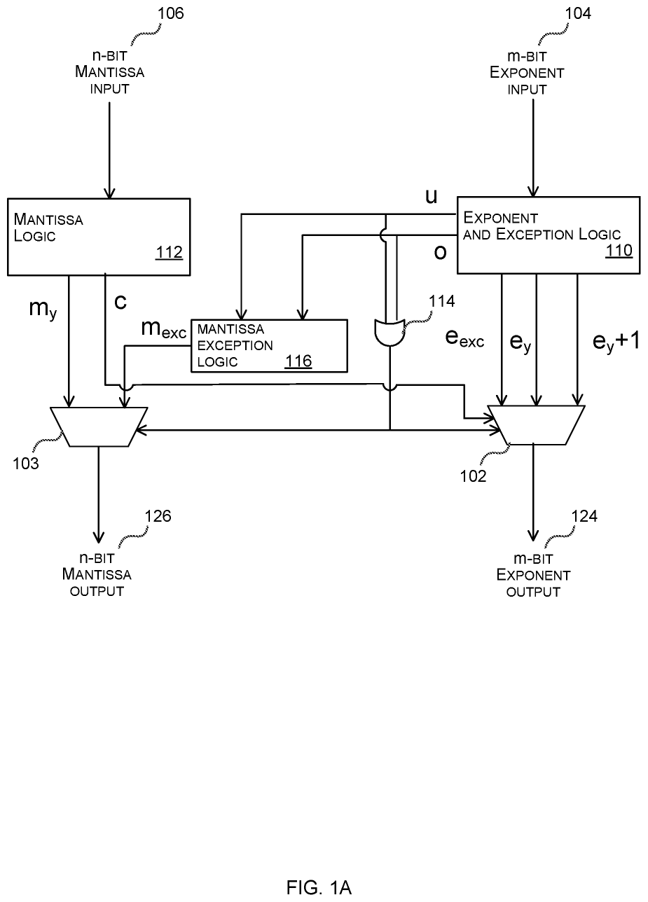

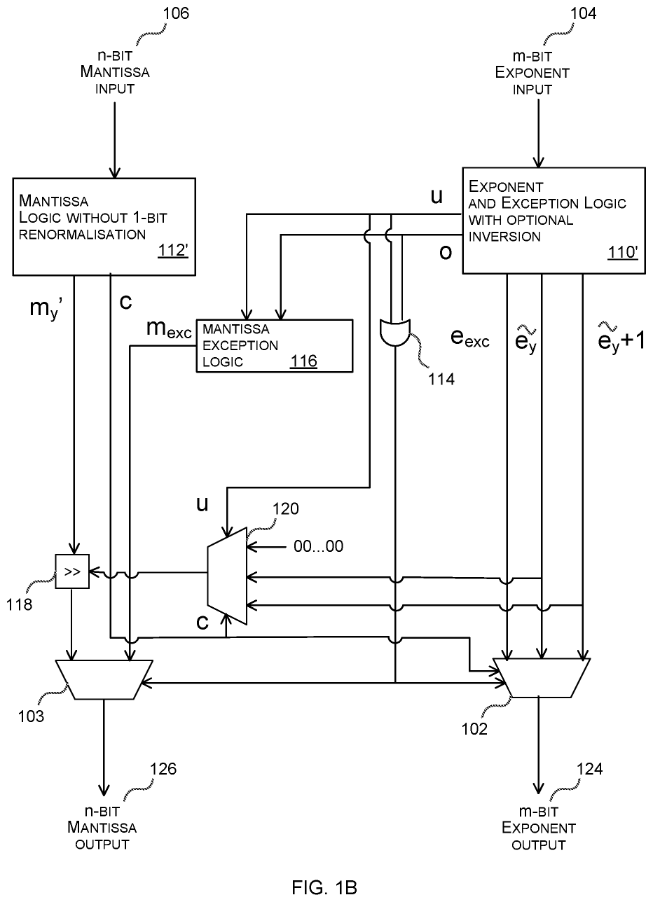

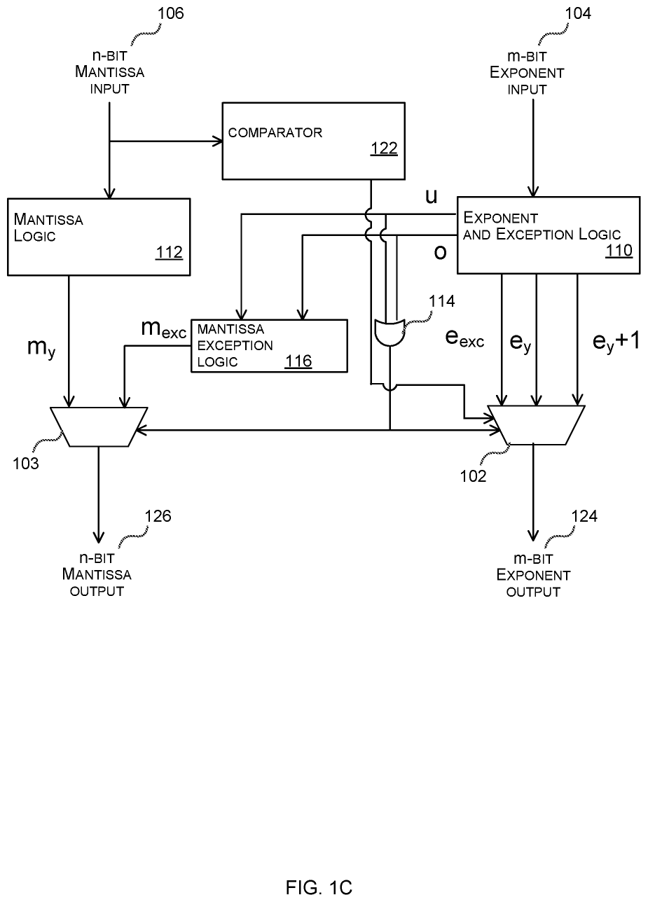

Described herein are efficient methods of performing squaring of floating point numbers in hardware logic with and without denormal output format support. As described in detail below, the methods reduce the amount of arithmetic performed when calculating the output exponent and performing exception handling to only an increment operation (which is significantly less costly in terms of hardware area and delay than an addition operation). In particular, the methods described herein avoid any need to perform explicit exponent unbiasing (i.e. they avoid the need to perform the explicit subtraction exp-bias) and share the single increment operation stated above to determine the denormaliser shift width, without any further arithmetic hardware even in the denormal-supporting variation of FIG. 1B. Furthermore, all variations determine exceptions without any dependence on the arithmetic significand squaring logic. By using the methods described herein, the amount of delay that is introduced by the hardware logic is reduced for both the exponent logic as well as the significand squaring logic, thanks to their independence, and the resulting hardware logic may be smaller than where known methods are used. The methods and hardware described herein may be implemented in a processor.

The methods described herein automatically operate correctly on floating point input numbers including denormal inputs whenever a floating point format and rounding mode are used that should return zero as the product of two denormal inputs (because its value is so small that the value is rounded to zero). This covers almost all useful floating point formats and most common rounding modes.

FIG. 1A is a schematic diagram of first example hardware logic arranged to perform squaring of a normal floating point number. In this method, all the underflow and overflow exceptions can be determined independently of the mantissa squaring logic, i.e. it can be determined whether the exponent will overflow or underflow without any knowledge of whether the mantissa overflows. This means that the determination of the output exponent (i.e. the exponent of the result of the squaring operation) can be performed substantially in parallel with the mantissa squaring (instead of sequentially) with the only interplay between the two operations being at the final stage of the mantissa and exponent logic paths (e.g. at the output multiplexers 102, 103) and this reduces the resultant delay. In various examples the exception detection may be performed in advance of the completion of the mantissa squaring operation and this allows more time to prepare particular exceptional output values and for fan out of exception bits to the output multiplexers 102, 103. As described above, as a consequence of the substantially parallel operation of the exponent logic and mantissa squaring logic and the use of bit manipulation and not arithmetic (with the exception of the increment operation), the overall size of the hardware may also be reduced.

Using the floating point notation from above, squaring of a normal floating point number may be written as follows:

$$[ {( - 1 )}^{sign} \times {2}^{exp - bias} \times 1. mant ] \times [ \text{} {( - 1 )}^{sign} \times {2}^{exp - bias} \times 1. mant ] = [ \text{} {( - 1 )}^{sign} \times {( - 1 )}^{sign} ] \times [ {2}^{exp - bias} \times {2}^{exp - bias} ] \times [ \text{} 1. mant \times 1. mant ] = [ \text{} {( - 1 )}^{sign + sign} ] \times [ {2}^{( exp - bias ) + ( exp - bias )} ] \times [ 1. mant \times 1. mant ]$$

Of these three terms, the first term, which is the output sign bit, is always zero. Calculating the second term (i.e. calculating 2exp-bias since the output exponent is biased) may be referred to as the calculation of the output exponent and is performed by the exponent path within the hardware, comprising the exponent and exception logic 110 and exponent output multiplexer 102. Calculating the third term (i.e. calculating 1.mant×1.mant) may be referred to as the significand squaring operation and is performed by the mantissa path within the hardware, comprising the mantissa logic 112, mantissa output multiplexer 103 and the mantissa exception logic 116. As shown in FIG. 1A, there is also logic 114 (an OR gate in the example shown) which generates the exception signal (as described in more detail below) that acts as a select signal for the two output multiplexers 102, 103.

As shown in FIG. 1A, the inputs are the m-bit exponent 104 and the n-bit mantissa 106 of the input floating point number. The exponent 104 is input to exponent and exception hardware logic 110 and in parallel, the mantissa 106 is input to mantissa logic 112. The mantissa logic 112 may perform the squaring of the significand in any manner such that it outputs an n-bit mantissa result, my, and in the event that the rounded squared significand is greater than or equal to 2 (a condition which may be referred to as the mantissa overflow condition), the mantissa logic 112 additionally a carry bit, c (this is a single bit because the leading one is in one of only two possible positions and hence only a single bit is required to indicate this). In the event that no exceptions occur (i.e. no underflow or overflow), this carry bit, c, is effectively added to the m-bit output from the exponent and exception logic 110 by selection of either the exponent generated in the exponent and exception hardware logic 110, ey, or an incremented version of that exponent, e_{y}+1, in the exponent output multiplexer 102, based on the carry bit, c. The output from the exponent output multiplexer 102 is the m-bit exponent result 124. In the event that an exception is identified by the exponent and exception logic 110, such that one of the exception signals u and o are high (where u being high indicates underflow and o being high indicates overflow) then the output from the exponent output multiplexer 102 is neither e_{y} nor e_{y}+1, but an exception exponent, e_{exc}. The value of the exception exponent, e_{exc}, is dependent upon the particular rounding mode used and is also output by the exponent and exception logic 110. In the example shown in FIG. 1, the two exception signals, u and o, are combined into a single signal (using an OR gate 114) and this provides a second select signal (which may be referred to as the exception signal) for the exponent output multiplexer 102 in addition to the carry bit, c. The output from the multiplexer 102 (e_{y}, e_{y}+1 or e_{exc}) is the m-bit exponent result 124. The overall output from the squaring operation therefore comprises the m-bit exponent result 124, the n-bit mantissa result 126 and optionally a sign bit, which, as discussed above, will always indicate that the result is positive (irrespective of the value of the sign bit in the input).

Overflow exceptions occur when the result of squaring the input floating point number is too large to be represented in the floating point format being used, e.g. where the resulting exponent is too large to be represented in the available m bits. Where an overflow exception is identified (i.e. o=1), the exponent squaring and exception logic 110 outputs a predefined exception exponent, e_{exc}, for overflow which is dependent upon the floating point format being used and the rounding mode. Similarly the mantissa exception logic 116 outputs a predefined exception mantissa, m_{exc}, for overflow which is dependent upon the floating point format being used and the rounding mode.

Underflow exceptions occur when the result of squaring the input floating point number is too small to be represented as a normal floating point number, i.e. a floating point number with a non-zero exponent, in the floating point format being used. Where an underflow exception is identified, the exponent and exception logic 110 outputs the predefined exception exponent, e_{exc}=0. Similarly, in FIG. 1A, the mantissa exception logic 116 outputs a predefined exception mantissa, m_{exc}=0, for underflow, as this variant flushes denormal outputs (i.e. denormal outputs are set to all zeros).

For the hardware arrangement shown in FIG. 1A, the output value is either a normal floating point number or zero. The hardware arrangement shown in FIG. 1B, described below, is a variation on that shown in FIG. 1A that can also output a denormal floating point number.

As shown in FIG. 1A, the addition of any carry, c, from the mantissa logic 112 to the exponent is performed by the selection of the appropriate input in the exponent output multiplexer 102, with the two outputs e_{y} and e_{y}+1 calculated in advance. This reduces the delay because the increment operation does not need to wait until the completion of the mantissa logic calculations (and hence the incrementor is not in the critical path).lt also allows the mantissa logic 112 more time to finish, saving area in its hardware implementation.

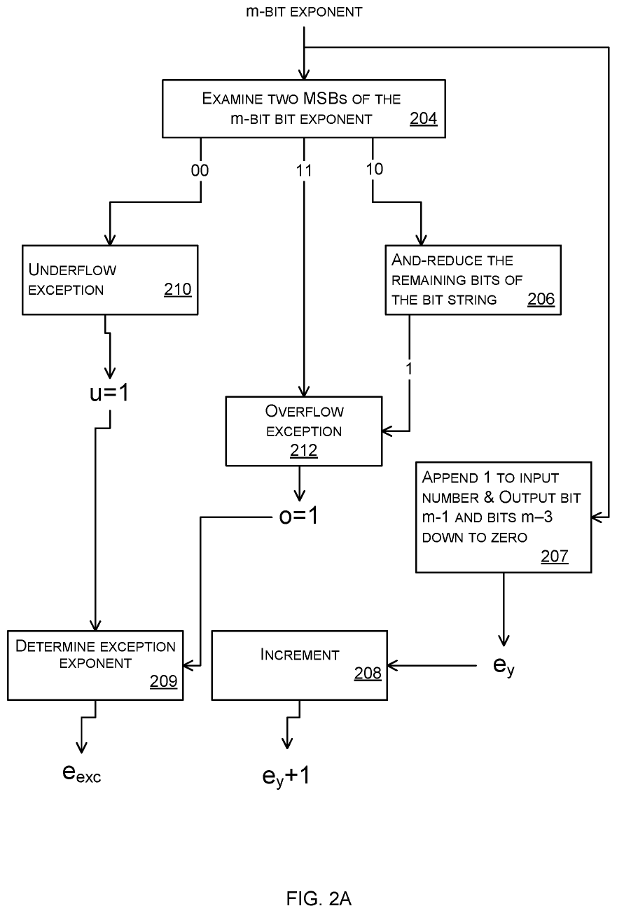

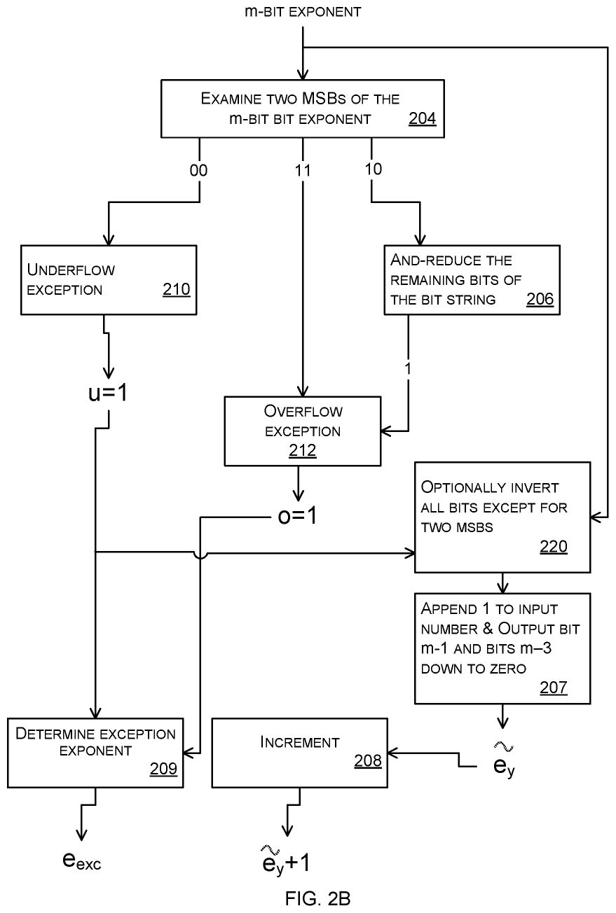

The operation of the exponent and exception logic 110 in the arrangement of FIG. 1A can be described in more detail with reference to FIGS. 2A, 3 and 4A. FIG. 2A is a flow diagram of an example method of operation of the exponent and exception logic 110. As shown in FIGS. 1A and 2A, the exponent and exception logic 110 receives as an input, the m-bit exponent 104 of the input number that is to be squared. The exception detection that is performed by the exponent and exception logic 110 involves bit manipulation of these m bits and does not involve any arithmetic, e.g. the exception detection does not involve either subtracting the bias or comparing the mantissa 106 of the input number to the square root of two. Additionally, as detailed above, the operation of the exponent and exception logic 110 is independent of the mantissa logic 112 and hence there is no input to the exponent and exception logic 110 from the mantissa logic 112.

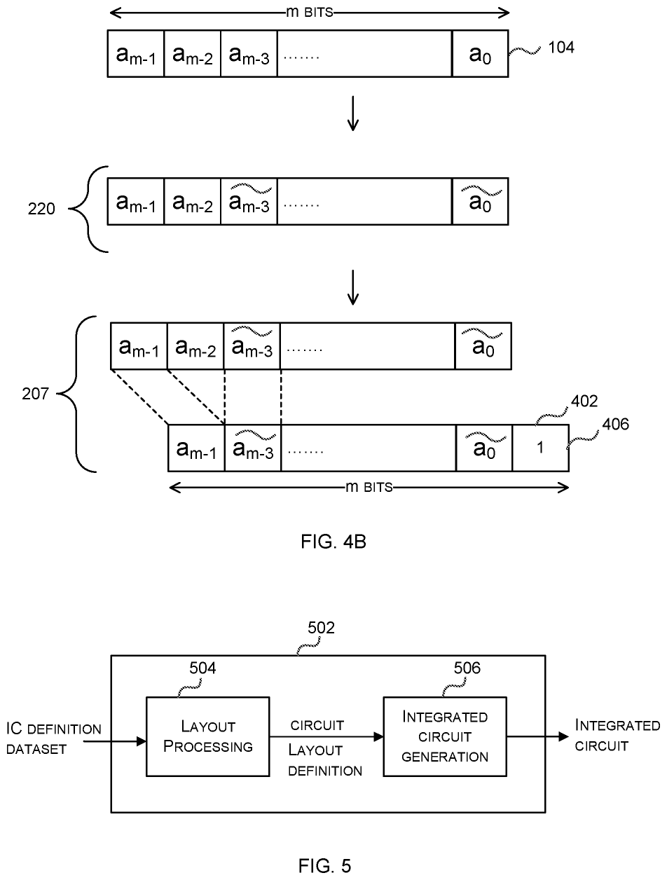

In the method shown in FIG. 2A, involves bit manipulation of the input m-bit exponent 104 which is shown graphically in FIG. 4A. In FIG. 4A the m bits of the input exponent 104 are denoted aₘ₋₁ to a₀, with aₘ₋₁ being the MSB (most significant bit) and ao being the LSB of the input exponent 104. The bit manipulation comprises examining the two MSBs (block 204) and AND-reducing the remaining bits of the m-bit input (block 206).

The examination of the two MSBs (in block 204) comprises determining if the two bits have the same value, i.e. 00 or 11, as both these bit pair values indicate an exception condition. If the two MSBs are both zeros (i.e. 00) this indicates an underflow exception (block 210) and as a result the value of u is set to one and the appropriate exception exponent (as dependent upon the rounding mode and floating point format) is determined (block 209). If the two MSBs are both ones (i.e. 11) this indicates an overflow exception (block 212) and as a result the value of o is set to one and the appropriate exception exponent (as dependent upon the rounding mode and floating point format) is determined (block 209).

The AND-reducing of the remaining bits of the input exponent (in block 206) in combination with the examination of the two MSBs (in block 204) is used to identify one further situation which results in an overflow exception (block 212). This situation occurs if the two MSBs are a one and a zero respectively (i.e. with the MSB being a one such that the two bits are 10) and all the remaining bits in the bit string are ones (i.e. the m-bit exponent is 101 . . . 1 where the bits represented by the ellipsis are all ones), such that the result of the AND-reduction (in block 206) is also a one. As above, where the bit values indicate an overflow condition, the value of o is set to one and the appropriate exception exponent (as dependent upon the rounding mode and floating point format) is determined (block 209).

No exceptions are identified (and no exceptions occur) if (i) the examination of the two MSBs (in block 204) identifies that they are not both the same value, the MSB is a one (i.e. 10) and the AND-reduction results in a zero or (ii) the examination of the two MSBs (in block 204) identifies that they are not both the same value and the MSB is a zero (i.e. 01), irrespective of the result of the AND-reduction. The m-bit exponent output 124 is generated in parallel with the exception determination logic (block 207) by outputting the MSB, aₘ₋₁, from the input m-bit exponent and bits aₘ₋₃ to a₀ from the input m-bit exponent and appending a one as LSB 402, as shown graphically in FIG. 4A. This means that the bit width does not exceed m at any point.

The bit manipulation (in block 207) has the effect of unbiasing the exponent and generating the exponent of the square without performing any addition operation. To square the floating point number, the exponent is multiplied by two and this is achieved by shifting all the bits by one bit position to the left. This occurs as a consequence of appending a one as the new LSB (in block 207). The unbiasing is achieved by the combination of the addition of one to the number, as occurs when the one is appended as LSB (in block 207), and the omission of the m-1^{th} bit when the output exponent is formed (in block 207).

As discussed above, the exponent and exception logic 110 outputs three candidate exponent values, one of which is then subsequently selected by the exponent output multiplexer 102. Generation of two of these values (e_{exc} and e_{y}, in blocks 209 and 207 respectively) has already been described and the third value, e_{y}+1, is generated using an incrementor (block 208).

Whilst FIG. 2A shows the AND-reduction only being performed in response to determining that the two MSBs are different and the MSB is a one (i.e. the two MSBs are 10), when implemented in hardware, the AND-reduction (in block 206) may be performed substantially in parallel with, or before, the examination of the two MSBs (in block 204), and hence irrespective of the values of the two MSBs, so as to reduce the overall delay.

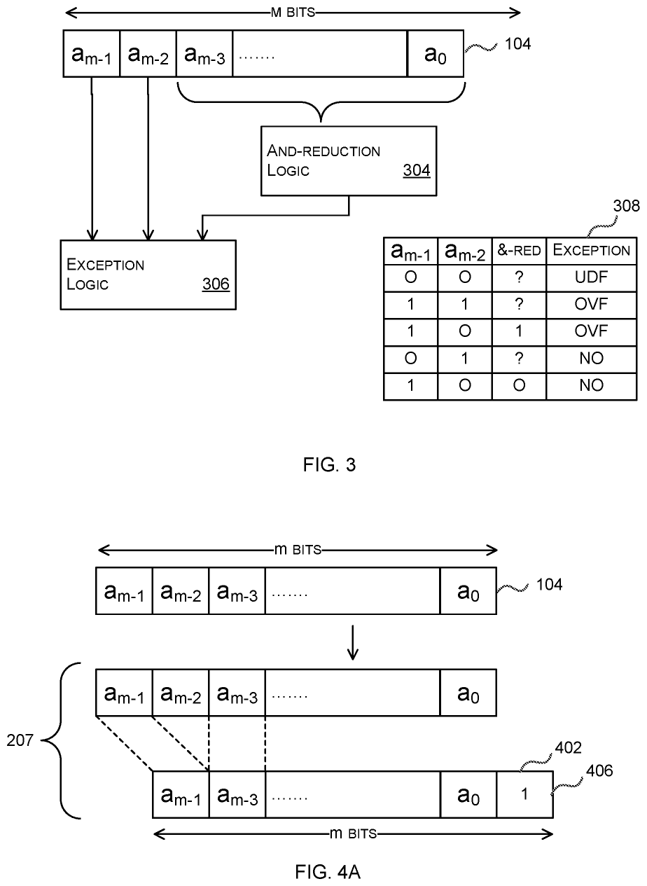

FIG. 3 is a schematic diagram showing an example implementation of a part of the exponent and exception logic 110 in more detail. As shown in FIG. 3, the exponent and exception logic 110 comprises AND-reduction logic 304 and exception hardware logic 306. As described above, the input 302 comprises the m-bit input exponent with or without an appended one. The AND-reduction logic 304 comprises an arrangement of logic gates or elements that outputs a one only if all the input bits (i.e. all bits aₘ₋₃ to a₀) are ones. If any one or more of these input bits are zeros, then the AND-reduction logic 304 outputs a zero. The exception hardware logic 306 comprises an arrangement of logic gates or elements which implement the truth table 308. In the truth table, the question marks indicate that the result of the AND-reduction is irrelevant to the finding of an underflow (UDF) or overflow (OVF) exception in that scenario.

There are many possible arrangements of logic gates (or equivalent logic elements) which result in the truth table 308 shown in FIG. 3. In an example, an underflow exception may be identified, and hence the value of u generated, by inputting bits aₘ₋₁ and aₘ₋₁ to a NOR logic element (i.e. u=aₘ₋₁ NOR aₘ₋₂). An overflow exception may be identified, and hence the value of o generated, by inputting bit aₘ₋₂ and the result of the AND-reduction, r, to an OR logic element and then inputting the output of the OR logic element and bit aₘ₋₁ to an AND logic element (i.e. o=aₘ₋₁ AND (aₘ₋₂ OR r)).

In the example of FIG. 3, the AND-reduction is shown as being performed (in the AND-reduction logic 304) before the rest of the bit manipulation. In other examples, however, it may be performed substantially in parallel and still feed its result into the exception hardware logic 306. Furthermore, whilst the AND-reduction logic 304 and exception hardware logic 306 are shown as separate functional blocks, it will be appreciated that in various implementations, the hardware logic of the two blocks may be combined and/or co-located.

As described above, for the hardware arrangement shown in FIG. 1A, the output value is either a normal floating point number or zero. FIG. 1B shows a schematic diagram of second example hardware logic arranged to perform squaring of a normal floating point number. The hardware arrangement shown in FIG. 1B is a variation on that shown in FIG. 1A that can also output a denormal floating point number.

The hardware arrangement shown in FIG. 1B functions in a similar manner to that described above with reference to FIG. 1A, with the following differences: (i) the mantissa logic 112′ omits the 1-bit renormalisation of the output value which is typically performed when performing squaring of a mantissa (and is performed in the mantissa logic 112 in FIG. 1A), (ii) the exponent and exception logic 110′ performs an optional inversion of all the bits in the output exponent ey except for the MSB prior to appending the one (in block 207), and (iii) there is an optional right-shift applied to the output, m_{y}′, from the mantissa logic 112′, in right-shifter 118, where the right-shifting is controlled by the output from an exception multiplexer 120. The second and third of these differences are described in more detail below.

The optional inversion occurs in the event of underflow (e.g. where u=1), as also shown in FIG. 2B. FIG. 2B is a flow diagram of an example method of operation of the exponent and exception logic 110′ and is a variation of that shown in FIG. 2A and described above. As shown in FIG. 2B, the inversion of all the bits in the m-bit exponent except for the two MSBs (block 220) is performed before the appending of a one (in block 207). The optional inversion (in block 220) depending on underflow determination is the only difference between FIGS. 2A and 2B.

FIG. 4B shows a graphical representation of the bit manipulation of the input m-bit exponent in the method of FIG. 2B. This differs from the representation shown in FIG. 4A because of the optional inversion that occurs (in block 220). In FIG. 4B the notation [symbol] is used (where i is the bit position and ranges from 0 to m-3) to indicate that these bits may optionally have been inverted.

In FIGS. 1B and 2B, the notation [symbol] and [symbol] +1 indicate that these correspond to the values of ey and ey+1 subject to the optional inversion based on the value of u. In the event of an underflow, the inverted values are never selected by the output exponent multiplexer 102, since the exception exponent e_{exc} will be selected; however, the inverted values are used in determining the right-shifting that is performed by the right-shifter 118. Where the inversion is performed, the resulting values are equal to bias-2exp, which is the amount of right shifting that is required. This provides an efficient way of determining the shift amount without performing any additional arithmetic, as the incrementor necessary in each variation can be shared to determine e_{y}+1 in the normal and [symbol] +1 in the denormal-supporting variation.

The exception multiplexer 120 selects between three inputs, a string of zeros, [symbol] and [symbol] +1, based on the value of u and the value of c. Where u=1 and c=0 (i.e. no mantissa overflow), then [symbol] is selected by the multiplexer 120 (which will be the inverted value of e_{y} since u=1) and used as the amount of right-shifting to perform (by right-shifter 118). Where u=1 and c=1 (i.e. mantissa overflow occurs), then [symbol] +1 is selected by the multiplexer 120 (which will be the inverted value of e_{y}+1 since u=1) and used as the amount of right-shifting to perform (by right-shifter 118). If u=0 then the string of zeros is selected and no shifting is performed, this ensures that denormalisation shifting (in right-shifter 118) is limited to the underflow case.

FIG. 1C shows a schematic diagram of third example hardware logic arranged to perform squaring of a normal floating point number. The hardware arrangement shown in FIG. 10 is a variation on that shown in FIG. 1A that does not use the carry from the mantissa logic 112 to control the exponent output multiplexer 102 but instead generates the equivalent select signal in a different way. As shown in FIG. 10, the select signal that replaces the carry signal is generated using a comparator 122 that compares the value of the mantissa input 106 to the square root of two. If the mantissa input 106 is less than the square root of two, then the output of the comparator 122 is zero, whereas if the mantissa input 106 is equal to, or more than, the square root of two, then the output of the comparator 122 is one.

By using a comparator 122, the exponent path is independent of the mantissa path and this may be used to reduce the delay in the exponent path. This may be particularly beneficial for implementations for floating point formats where the mantissas are short but the exponents are wide (i.e. smaller values of n and larger values of m), such as BFLOAT16 (n=7, m=8). However, if the mantissa is long (e.g. more than twice as long as the exponent as in the common half precision, single precision and double precision formats), then the arrangement of FIG. 1A may be more efficient in terms of both area and delay.

It will be appreciated that in other examples, the comparator 122 of FIG. 10 may be used in the arrangement shown in FIG. 1B, to avoid the use of the carry from the mantissa logic 112′ to control the exponent output multiplexer 102.

The hardware logic of FIGS. 1A, 1B, 10 and 3 are shown as comprising a number of functional blocks. This is schematic only and is not intended to define a strict division between different logic elements of such entities. Each functional block may be provided in any suitable manner. It is to be understood that intermediate values described herein as being formed by the hardware logic need not be physically generated by the hardware logic at any point and may merely represent logical values which conveniently describe the processing performed by the hardware logic between its input and output.

The methods described herein may be embodied in hardware on an integrated circuit. The hardware logic described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, System-on-chip, state machine, media processor, an application-specific integrated circuit (ASIC), a programmable logic array, a field-programmable gate array (FPGA), physics processing units (PPUs), radio processing units (RPUs), digital signal processors (DSPs), general purpose processors (e.g. a general purpose GPU), microprocessors, any processing unit which is designed to accelerate tasks outside of a CPU, etc. A computer or computer system may comprise one or more processors. Those skilled in the art will realize that such processing capabilities are incorporated into many different devices and therefore the term ‘computer’ includes set top boxes, media players, digital radios, PCs, servers, mobile telephones, personal digital assistants and many other devices.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture hardware logic configured to perform any of the methods described herein, or to manufacture a processor comprising any apparatus described herein. An integrated circuit definition dataset may be, for example, an integrated circuit description.

Therefore, there may be provided a method of manufacturing, at an integrated circuit manufacturing system, hardware logic configured to perform any of the methods described herein. Furthermore, there may be provided an integrated circuit definition dataset that, when processed in an integrated circuit manufacturing system, causes the method of manufacturing such hardware logic to be performed.

An integrated circuit definition dataset may be in the form of computer code, for example as a netlist, code for configuring a programmable chip, as a hardware description language defining an integrated circuit at any level, including as register transfer level (RTL) code, as high-level circuit representations such as Verilog or VHDL, and as low-level circuit representations such as OASIS (RTM) and GDSII. Higher level representations which logically define an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture hardware logic configured to perform any of the methods described herein will now be described with respect to FIG. 5.

FIG. 5 shows an example of an integrated circuit (IC) manufacturing system 502 which is configured to manufacture hardware logic configured to perform any of the methods described herein. In particular, the IC manufacturing system 502 comprises a layout processing system 504 and an integrated circuit generation system 506. The IC manufacturing system 502 is configured to receive an IC definition dataset (e.g. defining hardware logic configured to perform any of the methods described herein), process the IC definition dataset, and generate an IC according to the IC definition dataset (e.g. which embodies hardware logic configured to perform any of the methods described herein). The processing of the IC definition dataset configures the IC manufacturing system 502 to manufacture an integrated circuit embodying hardware logic configured to perform any of the methods described herein.

The layout processing system 504 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 504 has determined the circuit layout it may output a circuit layout definition to the IC generation system 506. A circuit layout definition may be, for example, a circuit layout description.

The IC generation system 506 generates an IC according to the circuit layout definition, as is known in the art. For example, the IC generation system 506 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 506 may be in the form of computer-readable code which the IC generation system 506 can use to form a suitable mask for use in generating an IC.

The different processes performed by the IC manufacturing system 502 may be implemented all in one location, e.g. by one party. Alternatively, the IC manufacturing system 502 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture hardware logic configured to perform any of the methods described herein without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 5 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 5 the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.”

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A method of squaring a floating point number in hardware logic, the floating point number comprising an m-bit input exponent and an input mantissa, the method comprising:
generating a candidate mantissa output, in mantissa hardware logic, by squaring the input mantissa;
generating, in exponent and exception logic, three candidate exponent outputs, the three candidate exponent outputs comprising an exceptional exponent output, an exponent output generated from the m-bit input exponent and an incremental exponent, wherein the incremental exponent is generated by incrementing the exponent output generated from the m-bit exponent;
selecting, as an output mantissa, either the candidate mantissa output or an exceptional mantissa output based on exception signals generated by the exponent and exception logic based on the m-bit input exponent; and
selecting, as an output exponent, one of the three candidate exponent outputs based on the exception signals generated by the exponent and exception logic and based on a signal indicating a mantissa overflow condition.

2. The method according to claim 1, wherein the signal indicating the mantissa overflow condition is output by the mantissa hardware logic.

3. The method according to claim 1, wherein the signal indicating the mantissa overflow condition is generated by a comparator, and wherein the comparator is configured to compare the input mantissa to a square root of two.

4. The method according to claim 1, wherein generating the exponent output comprises:
appending a one to the m-bit input exponent and outputting bits m-1 and m-3 to zero.

5. The method according to claim 4, wherein the exception signals generated by the exponent and exception logic comprise an underflow exception signal;
wherein generating the exponent output comprises, in response to the underflow exception signal indicating an underflow condition, inverting all bits of the m-bit input exponent except for bits m-1 and m-2 prior to appending the one; and
wherein generating the candidate mantissa output comprises:
squaring the input mantissa and outputting a result without performing 1-bit renormalisation; and
performing right shifting of the result, in a shifter, by a number of bits selected from zero bits, a number of bits corresponding to the exponent output generated from the m-bit input exponent and a number of bits corresponding to the incremental exponent, wherein the selection is based on the signal indicating a mantissa overflow condition and the underflow exception signal.

6. The method according to claim 1, further comprising generating exception signals in the exponent and exception logic based on the m-bit input exponent, the exception signals comprising an underflow exception signal and an overflow exception signal and wherein the exception signals are generated based on values of bits m-1 and m-2 of the m-bit input exponent.

7. The method according to claim 6, wherein the overflow exception signal is further generated based on an AND-reduction of bits m-3 to zero of the m-bit input exponent.

8. Hardware logic arranged to square a floating point number, the floating point number comprising an m-bit input exponent and an input mantissa, the hardware logic comprising:
mantissa hardware logic arranged to generate a candidate mantissa output by squaring the input mantissa;
exponent and exception logic arranged to generate three candidate exponent outputs, the three candidate exponent outputs comprising an exceptional exponent output, an exponent output generated from the m-bit input exponent and an incremental exponent, wherein the incremental exponent is generated by incrementing the exponent output generated from the m-bit exponent;
a first multiplexer arranged to select, as an output mantissa, either the candidate mantissa output or an exceptional mantissa output based on exception signals generated by the exponent and exception logic based on the m-bit input exponent; and
a second multiplexer arranged to select, as an output exponent, one of the three candidate exponent outputs based on the exception signals generated by the exponent and exception logic and based on a signal indicating a mantissa overflow condition.

9. The hardware logic according to claim 8, wherein the mantissa hardware logic is further arranged to output the signal indicating the mantissa overflow condition.

10. The hardware logic according to claim 8, further comprising a comparator arranged to generate the signal indicating the mantissa overflow condition by comprising the input mantissa to a square root of two.

11. The hardware logic according to claim 8, wherein the exponent and exception logic is arranged to generate the exponent output by:
appending a one to the m-bit input exponent and outputting bits m-1 and m-3 to zero.

12. The hardware logic according to claim 11, wherein the exception signals generated by the exponent and exception logic comprise an underflow exception signal;
wherein the exponent and exception logic is further arranged to generate the exponent output by, in response to the underflow exception signal indicating an underflow condition, inverting all bits of the m-bit input exponent except for bits m-1 and m-2 prior to appending the one; and
wherein the mantissa hardware logic is arranged to generate the candidate mantissa output by:
squaring the input mantissa and outputting a result without performing 1-bit renormalisation; and
performing right shifting of the result, in a shifter, by a number of bits selected from zero bits, a number of bits corresponding to the exponent output generated from the m-bit input exponent and a number of bits corresponding to the incremental exponent, wherein the selection is based on the signal indicating a mantissa overflow condition and the underflow exception signal.

13. The hardware logic according to claim 8, wherein the exception signals comprise an underflow exception signal and an overflow exception signal and wherein the exponent and exception logic is arranged to generate the exception signals based on values of bits m-1 and m-2 of the m-bit input exponent.

14. The hardware logic according to claim 13, wherein the exponent and exception logic is arranged to generate the overflow exception signal based on an AND-reduction of bits m-3 to zero of the m-bit input exponent.

15. The hardware logic according to claim 8, wherein the hardware logic is embodied in hardware on an integrated circuit.

16. A method of manufacturing, using an integrated circuit manufacturing system, hardware logic as set forth in claim 8, comprising inputting a computer readable dataset description of said hardware logic into an integrated circuit manufacturing system, causing the integrated circuit manufacturing system to manufacture the hardware logic according to the dataset description.

17. A non-transitory computer readable storage medium having stored thereon an integrated circuit definition dataset that, when processed in an integrated circuit manufacturing system, configures the integrated circuit manufacturing system to manufacture hardware logic as set forth in claim 8.

18. An integrated circuit manufacturing system configured to manufacture hardware logic as set forth in claim 8.

19. An integrated circuit manufacturing system comprising:
a non-transitory computer readable storage medium having stored thereon a computer readable dataset description of an integrated circuit that describes hardware logic as set forth in claim 8;
a layout processing system configured to process the integrated circuit description so as to generate a circuit layout description of an integrated circuit embodying the hardware logic; and
an integrated circuit generation system configured to manufacture the hardware logic according to the circuit layout description.
